(19) United States
(12) Patent Application Publication
(10) Pub. No.: US 2004/0000179 A1
(43) Pub. Date: Jan. 1, 2004

(54) Method for composting organic wastes

(76) Inventor: Yoshiharu Hiraki, San Mateo, CA (US)

Correspondence Address: Rosenthal & Osha L.L.P., Suite 2800, 1221 McKinney, Houston, TX, 77010, US

(21) Appl. No.: 10/186,240

(22) Filed: Jun. 28, 2002

(51) Int. Cl. C05F 11/08

(52) U.S. Cl. 71/10

(57) ABSTRACT

A method for composting organic wastes, including chopping the organic wastes, adjusting water content of the chopped organic wastes to about 20%-40% by weight, mixing an effective amount of EM-fermented feed with the chopped organic wastes such that the EM-fermented feed is substantially evenly distributed in the chopped organic wastes, and storing the chopped organic wastes having the EM-fermented feed in a closed container at suitable temperature for a predetermined period of time such that the chopped organic wastes are composted in the closed container by fermentation.

### BACKGROUND OF INVENTION

There are roughly two methods for composting organic wastes, such as kitchen wastes or green wastes, by utilizing the activity of microorganism. One is a method wherein organic wastes are composted by aerobic fermentation which requires stirring to expose the organic wastes to outside air. The other is a method wherein organic wastes are composted by anaerobic fermentation in a closed anaerobic atmosphere using anti-oxidation type microorganism.

The former method has been broadly employed so far because composts can be relatively easily and inexpensively produced. However, because this method composts the organic wastes under a condition exposed to outside air, various germs easily contact the organic wastes and the oxygen in the outside air get easily bonded with the organic wastes, causing putrefaction of the organic wastes. As a result, bad smell is caused and the surrounding environment is contaminated. In addition, the compost produced by the method often contains germs and are poor in quality.

On the other hand, the latter method uses EM or EM BOKASHI produced by mixing a specific anti-oxidation type anaerobic microorganism and anaerobic microorganism, and decomposes organic wastes by fermentation under a anaerobic atmosphere wherein organic wastes/microorganism are shut off from outside air. Here, EM (Effective Microorganism) generally refers to a mixture of more than ten kinds of useful anti-oxidation type microorganisms, such as Lactic acid bacteria, Yeast, Phototropic bacteria, azotobacter, or ray fungus, which usefully work for environment and organisms. EM BOKASHI generally refers to a powder material produced by adding molasses and water to the EM and breed the microorganisms, and then mix the bred EM with organic matters, such as rice bran, oil cake, fish meal, bran, or wheat powder, wherein EM can easily breed, and breed the mixture by fermentation in a closed condition, and dry. According to this method, because the fermentation is performed in anaerobic condition being shut-off from outside air, intrusion of various germs is prevented and therefore compost with high quality can be produced, because the processing is conducted in a closed system, even when putrefaction unfortunately occurred, surrounding hygienic environment is not contaminated. For these reasons, fermentation using EM has called a particular attention as a method that can solve the environmental issues, which is strictly regulated in recent years.

However, in order to use this method, several environmental conditions (anaerobic condition, temperature, moisture etc.) for active performance of EM during the fermentation need to be satisfied. If one condition among those conditions is not satisfied, putrefaction of organic wastes with strong smell may occur, or may result in a failure of obtaining desired composted product due to insufficient progress of fermentation. For this reason, composting organic wastes using EM costs very expensive, and often end up with a failure of composting due to not satisfying the necessary condition for fermentation.

In addition, the organic wastes used as a raw material often contains seeds of weed. In a case of the aerobic fermentation, those seeds can be killed by the high temperature caused during the fermentation. However, in a case of the anaerobic fermentation, temperature does not go so high that seeds of weed contained in the organic wastes may remain alive in the produced compost, and after the compost is distributed into the soil, those seeds germinate and grow, affecting badly to the cultivation of crops. Therefore, it becomes necessary to subject the produced compost to heat treatment to kill those seeds to avoid that happening, causing further increase of production cost of compost.

Therefore, what is needed is a method for composting which can solve the above problems and mass produce compost on a commercial basis stably, efficiently, and inexpensively.

### SUMMARY OF INVENTION

In general, in one aspect, the present invention relates to a method for composting organic wastes. The method comprises chopping the organic wastes, adjusting water content of the chopped organic wastes to about 20%-40% by weight, mixing an effective amount of EM-fermented feed with the chopped organic wastes such that the EM-fermented feed is substantially evenly distributed in the chopped organic wastes, and storing the chopped organic wastes having the EM-fermented feed in a closed container at suitable temperature for a predetermined period of time such that the chopped organic wastes are composted in the closed container by fermentation.

In general, in one aspect, the present invention relates to a method for composting partially putrefacted organic wastes. The method comprises chopping partially putrefacted organic wastes having water content of more than 40% by weight, drying the chopped organic wastes by heating the chopped organic wastes at a temperature above 100° C. and stirring the heated chopped organic wastes such that the water content of the chopped organic wastes becomes less than 20% by weight, adjusting water content of the dried chopped organic wastes to about 20%-40% by weight, mixing effective amount of EM-fermented feed with the chopped organic wastes and stirring the chopped organic wastes such that the EM-fermented feed is substantially evenly distributed in the chopped organic wastes, and storing the organic wastes having the EM-fermented feed in a closed container at a suitable temperature for a predetermined period of time such that the chopped organic wastes are composted in the closed container by fermentation.

Other aspects and advantages of the invention will be apparent from the following description and the appended claims.

### BRIEF DESCRIPTION OF DRAWINGS

FIG. 1 is a schematic of a preconditioning apparatus which can be used for conducting the method for composting organic wastes according to the present invention.

FIG. 2 is a schematic of a fermentation tank which can be used for conducting the method for composting organic wastes according to the present invention.

FIG. 3 is a front view of a fermentation tank which can be used for conducting the method for composting organic wastes according to the present invention.

FIG. 4 is a perspective view of a drum used for the experiment for proving the effectiveness of the method for composting organic wastes according to the present invention.

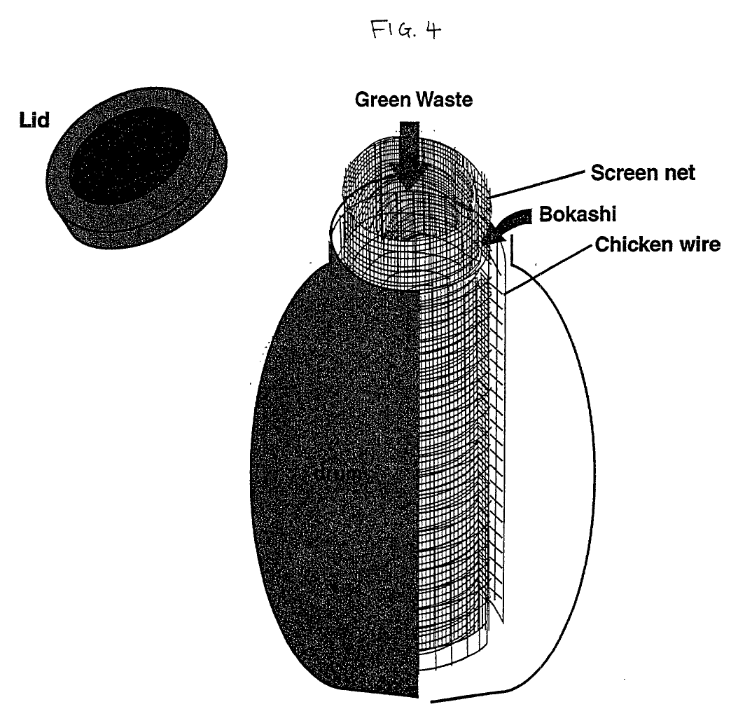

### DETAILED DESCRIPTION

Referring to the drawings, the embodiment of the method for composting organic wastes according to the present invention is explained in detail as follows.

### (Preparation of EM Diluted Solution, EM Activated Solution, and EM-Fermented Feed)

Generally, EM is a mixture of about ten kinds of anti-oxidation type microorganisms, such as lactic acid bacteria, yeast, phototropic bacteria, etc. However, EM that can be used for the present invention does not need to contain all of these ten kinds of microorganisms. As far as the EM contains at least lactic acid bacteria, yeast, and phototropic bacteria, it can achieve the advantage of the present invention. EM can be purchased in a form of mixed culture solution of the above plural kinds of microorganism from an outside entity, for example, EM technology Inc. located at Tucson, Ariz. Alternatively, instead of purchasing the already mixed culture solution from a seller, EM culture solution can be obtained by purchasing microbial strains of the microorganism in a freeze dried or frozen state from a microorganism bank (for example, cell bank), transferring each of the microbial strains (which contains at least the above three kinds of microorganism) to a flask filled with a culture solution to culture the microbial strains for a certain period of times, and mixing them.

The above EM culture solution is then mixed with molasses preferably in approximately equal volume ratio, and diluted by water, preferably boiled water, to obtain EM diluted solution. The EM diluted solution thus prepared (preferably diluted twenty times the volume of the EM culture solution) can be used to obtain EM activated solution by storing the EM diluted solution in a closed container and subjecting it to anaerobic fermentation for two weeks. Further, the EM diluted solution is mixed with rice bran, oil cake, or fish meal etc., preferably such that water content of those becomes 25-35 by weigh % and stirred, and under that condition, those materials are subjected to anaerobic fermentation and dried and powdered to obtain EM-fermented feed. The above mixing is preferably conducted such that volume ratio of rice bran etc. to EM 100 times diluted solution is 10:1. The EM-fermented feed used in the present invention includes the organic matter generally called as EM BOKASHI. But it is not limited to the EM BOKASHI. Any organic matter which can be used for proliferation of EM by anaerobic fermentation and processed in powder form can be used as the EM-fermented feed for the present invention.

### (Preparation of Organic Wastes to Be Composted)

The organic wastes used as the raw material under the present invention can be collected from individual's home kitchen, house yard, restaurants, forests, or farm yards. These collected organic wastes sometimes have putrefaction and bad smell. In that event, the bad smell can be eliminated by splashing the EM activated solution thereon. Then, plastics pieces or metals, which cannot be decomposed in the soil, are removed from the organic wastes, and then the organic wastes are cut into 1-2 cm long pieces by using a cutter (not shown).

### (Preconditioning Process for Anaerobic Fermentation)

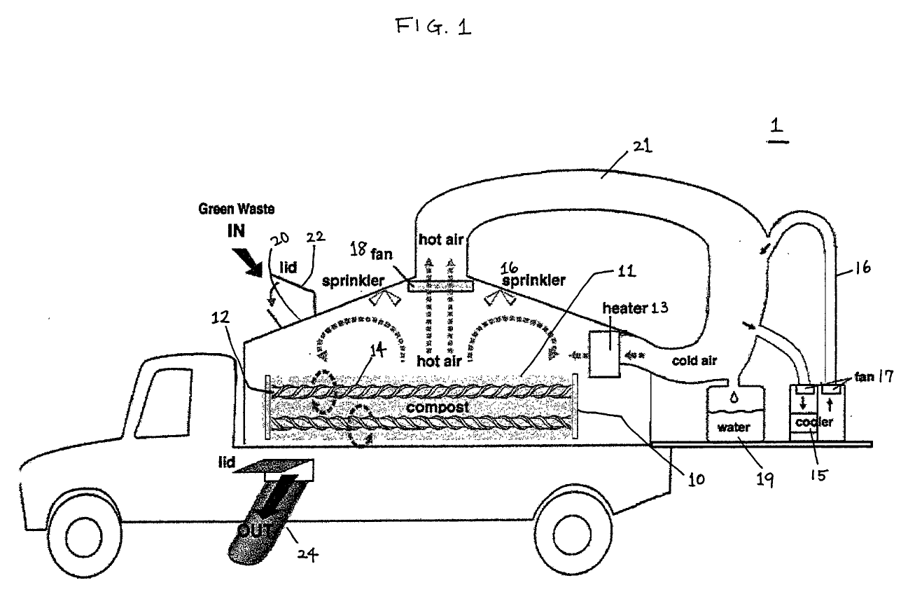

The organic wastes thus cut are input into a preconditioning apparatus 1 shown in FIG. 1 through an inlet 20. If this preconditioning apparatus 1 is placed on a carrier bed of a mobile track, it becomes possible to freely carry the preconditioning apparatus can to the places where the organic wastes are collected. It is convenient not only for collecting the organic wastes from farm yard etc. but also for carrying the organic wastes already subjected to the preconditioning to the fermentation tank, which is described later.

After storing the organic wastes cut into pieces into the preconditioning apparatus 1 and closing a covering door 20 such that the organic wastes are shut out from outside air, the organic wastes are chopped into as small pieces as possible by using a chopping/stirring apparatus 11. The chopping/stirring apparatus 11 has a structure wherein a plurality of lateral sticks horizontally bridged across the organic wastes tank 10 in the preconditioning apparatus 1 and the plurality of lateral sticks are equipped with a plurality of metal cutters. The plurality of lateral sticks spin under that state such that the organic wastes stored in the organic wastes tank 10 are chopped and stirred by the spinning of the lateral sticks.

The organic wastes, while being chopped and stirred as described above, are heated for more than 15 minutes by heating inside of the apparatus up to 100° C. by electric heater 13. By doing this, water contained in the chopped organic wastes is phase shifted into water vapor, and the pressure inside the closed preconditioning apparatus 1 becomes high due to the excess water vapor. Most of the various germs and seeds of plants are killed during this process.

Next, temperature inside the apparatus is controlled to be 40° C. by manipulating an electric heater 13, and under that condition, a cooling apparatus 15 and a cooling air blowing fan 17 disposed in the preconditioning apparatus are actuated. As illustrated in FIG. 1, the cooling apparatus is disposed outside the preconditioning apparatus 1. A cooled air passage 16 connected to the cooling apparatus 15 is connected to inside of the air cycling passage of the preconditioning apparatus 1. The water vapor generated in the preconditioning apparatus 1 by heating the organic wastes at a high temperature is contacted with the cooled air blown from the cooling apparatus 15 and cooled down and separated into water and air. The cooled air by this process is cycled within the cycling passage by the air blower 18, and then is contacted with cold air again and is cooled down such that the water vapor contained in the air is separated into water and cooled air. By repeating this process for a certain period of time, the chopped organic wastes is adjusted to be suitable temperature, for example, 36° C.-40° C., and water content 20%-40% by weight, preferably 25%-35% by weight. In the above process, the water separated from the water vapor is collected into a water collecting tank 19. By adjusting the water content of the chopped organic wastes to be 20%-40%, preferably 25%-35% like the above, an idealistic state for the anaerobic fermentation of organic wastes using EM-fermented feed is realized.

If the water content of the organic wastes is less than 20% by weight, subsequent anaerobic fermentation does not proceed or proceeds very slowly. If it is more than 40% by weight, putrefaction may occur and possibility of failure of the anaerobic fermentation becomes high.

Preferably, the above process is further repeated for a longer period of time such that the chopped organic wastes is maintained at a suitable temperature, for example, 36° C.-40° C., water content to be less than 20% by weight, preferably less than 10% by weight. Thereafter water or 100 times diluted EM dilute solution is splashed onto the organic wastes such that the water content of the organic wastes is recovered to 20%-40% by weight, preferably 25%-35% by weight. By having a step wherein the organic wastes is once heavily dried, it becomes possible to prevent that putrefaction of the organic wastes when they are collected causes bad effect to the subsequent anaerobic fermentation of the organic wastes.

In order to avoid oxidation or putrefaction of the organic wastes, it is preferable that chopping of the organic wastes and adjusting water content thereof are conducted under a condition in which the organic wastes are shut out from the outside air.

After finishing the water content adjustment process, the covering door 20 is opened and the EM-fermented feed powder prepared in advance is input into the preconditioning apparatus 1 through the inlet 20. After that, the cover 22 is closed, and the EM-fermented feed and the organic wastes are stirred by using the chopping/stirring device 11 such that they are mixed together. In this case, the amount of EM-fermented feed to be input can be 3% of the total weight of the organic wastes to be processed. Generally, in order to conduct the anaerobic fermentation of organic wastes by using EM BOKASHI powder, 20% by weight or more of the total weight of the organic wastes to be fermented is used in order to absorb the water that is generated during the fermentation process. However, according to the method of the present invention, because the water content of the organic wastes is already adjusted to be about 20%-40% by weight, preferably 25%-35% by weight, there is very little need to absorb water by the EM-fermented feed. For this reason, it is not necessary to use a large amount of EM-fermented feed to absorb water.

Because the EM-fermented feed contains anaerobic microorganisms, it is preferable that the process for mixing the EM-fermented feed with the organic wastes in anaerobic atmosphere being shut out from outside air.

### (Anaerobic Fermentation)

Next, the process is proceeded to the anaerobic fermentation process of the organic wastes that are already subjected to the preconditioning by using EM. There are two methods that can be used on a commercially basis.

1. Anaerobic Fermentation in a Bag

The chopped organic wastes having EM-fermented feed evenly mixed therein is taken out from the preconditioning apparatus 1 through the outlet 24 thereof, and are packed in a delivery bag and the bag is closed. It is preferable that the inside of the delivery bag is covered with plastic sheet that shields air. Also, at the time of packing the organic wastes air tightly, it is preferable that the bag is closed such that air does not come inside the bag. The organic wastes thus packed in a bag such that outside air does not come inside the bag is then subjected to anaerobic fermentation in this state due to the activity of the EM mixed therein. A user can open the bag after a certain period of time necessary for completing the anaerobic fermentation, for example, one month, and use the product as compost. At the time of delivery to users, if the period necessary for completing the fermentation is described on an indication portion of the bag together with the production date thereof, the user can find whether the content has reached a state wherein the product can be used as compost by seeing the description.

2. Anaerobic Fermentation in a Fermentation Tank

In stead of immediately packing the organic wastes after mixing with the EM-fermentation feed, the organic wastes can be taken out from the preconditioning apparatus 1 and transferred to a separate large fermentation tank 30. The organic wastes are then subjected to anaerobic fermented in that state. By doing this a large volume of organic wastes are reliably composted at one time. When organic wastes need to be delivered in a composted state, this method is employed.

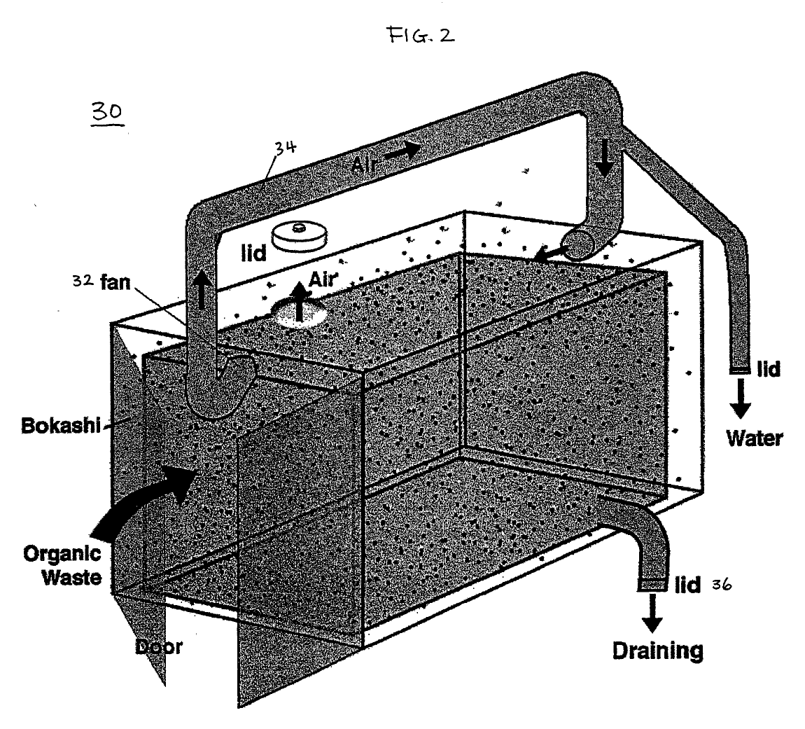

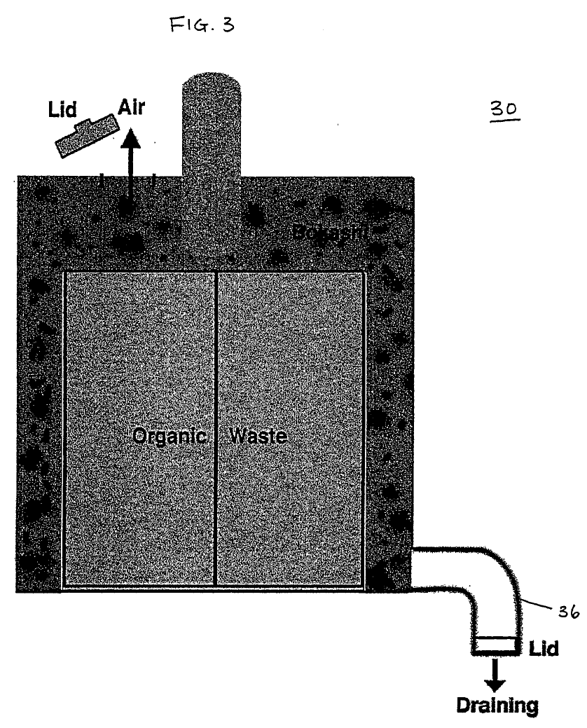

Specifically, the organic wastes evenly mixed with the EM-fermentation feed by stirring are taken out of the preconditioning apparatus 1 through the outlet 24 by using, for example, a belt conveyor, and then re-stored in the large fermentation tank 30 as shown in FIGS. 2 and 3. At this time, because the organic wastes containing EM need to be taken out of the preconditioning apparatus, the organic wastes are inevitably exposed to outside air. In order to avoid contacting with outside air, it is preferable that such re-storing of the organic wastes is performed as promptly as possible. In addition, when re-storing the organic wastes into the fermentation tank 2 thus taken out, it is preferable that the organic wastes are stored therein as densely as possible by applying compression thereon.

The fermentation tank 30 is, for example, a large container made of aluminum formed in a rectangular parallelepiped shape. Inner wall of the container is formed in a double layer structure having aluminum inner wall and a fine mesh net sheet attached to the inner wall. Preferably, EM-fermentation feed powder that helps fermentation of the organic wastes is provided between the aluminum inner wall and the net sheet. The EM-fermentation feed powder not only helps the fermentation of the organic wastes at a peripheral portion of the organic wastes stored in the tank which are fermented relatively slowly compared to the core portion of the organic wastes but also absorbs excessive water generated from the organic wastes during the anaerobic fermentation process so that damaging the fermentation tank due to high temperature water is prevented.

In the fermentation tank 30, the organic wastes containing the EM-fermentation feed is then placed in a quiet place for a predetermined period of time at a suitable temperature, for example, at 10-45° C. Preferably, the fermentation tank 30 is equipped with a fan 32 for blowing air, a pipe 34 for circulation of air, and a water drain outlet 36 therein so that the water generated during the fermentation can be removed from the tank. The period necessary for placing the organic wastes in a quiet place varies depending on the fermentation temperature, water content etc. However, if the temperature in the tank is 25-35° C. and water content is 30% by weight, the anaerobic fermentation is completed in about two weeks. The organic wastes which completed the anaerobic fermentation process can be shipped to customer as a final product of organic manure.

Preferably, the anaerobic fermentation is conducted such that the fermentation tank is once opened to stir the content so that the organic wastes are exposed to outside air and thereafter the organic wastes are restored to complete the anaerobic fermentation of the organic wastes. By exposing the organic wastes one time during the anaerobic fermentation, putrefaction does not occur and anaerobic fermentation is further promoted so that the composting the organic wastes can be completed faster. The reason of this is not necessary clear. However, according to the knowledge of inventor, the aerobic microorganism contained in EM is placed in an extreme anaerobic condition. Under that condition, if the organic wastes are exposed to outside air, the state of the aerobic microorganism is softened so that the activity of the aerobic microorganism is enhanced.

### (Experiment)

The advantage derived from the present invention has been confirmed by comparing the result of using the present invention with the result of not using the present invention wherein green wastes including yard clippings of lawn and fallen leaves are composted by anaerobic fermentation using EM BOKASHI.

The EM diluted solution and EM BOKASHI used in this experiment is prepared in accordance with the following method.

First, EM culture solution (Kyusei EM™ MICROBIAL INOCULANT) is purchased from EM technology Inc. (1802 West Grand Road, Suite 122, Tucson, Ariz. 85754), and the EM culture solution is mixed with molasses in a volume ratio of EM solution 0.5 gallon/molasses 0.5 gallon, and then 10 gallons of boiled water was added so that the EM culture solution is diluted 20 times obtaining 11 gallons of 20 times diluted EM diluted solution.

Next, 5 gallons of the 20 times diluted EM diluted solution is added to 50 gallons of rice bran (produced by Tamaki rice production farm at Redding Calif.) and stirred so that the EM diluted solution is evenly mixed with the rice bran. Thereafter, water content of the rice bran is adjusted to be approximately 20%-40% by weight and then placed in a closed container for a month under that condition so that anaerobic fermentation occurs. And then, after completing the anaerobic fermentation, the rice bran thus fermented was dried to obtain EM BOKASHI in powder form.

Next, 30 gallons of boiled water is added to the remaining 6 gallons of 20 times diluted EM solution to obtain 100 times diluted EM diluted solution.

Next, 1 ton of green wastes including yard clippings of lawn and fallen leaves is collected from gardeners, and after eliminating impurities, such as plastics or metals, the green wastes are chopped by using a chopping machine so that the green wastes are all cut within 1-2 centimeter square size. The water content of the green wastes thus finely cut was measured by using a hygrometer. As a result, the water content of the green wastes turned out to be approximately 50% by weight.

Approximately 50 gallons of green wastes thus chopped is taken out and stored into a 55 gallons drum to obtain Experiment Material 1.

The remainder of the green wastes is dried by spreading them on a concrete plate and sun dried for half a day by stirring on the plate so that water content of them becomes approximately 25%-35% by weight. Then, approximately 50 gallons of the green wastes were packed into three 55 gallon drums each to obtain Experiment Material 2, Experiment Material 3, and Experiment Material 4.

Remainder of the above green wastes is exposed to outside air for two days so that putrefaction has partially occurred. Then, 50 gallons of the partially putrefacted green wastes has been taken out and stored in the drum to be made as Experiment Material 5.

The remainder of the above partially putrefacted green wastes are spread over a concrete plate and exposed to sun light for a day so that the green wastes has been dried to the extent that water content of the green wastes becomes about less than 10%. Thereafter, one gallon of 20 times diluted EM diluted solution has been splashed over the mixture and stirred so that the water content of the mixture is recovered to the same water content level as that of Experiment Material 5. And then, the green wastes thus treated are stored in a 50 gallons drum to be made as Experiment Material 6.

### Experiment 1 (Experiment Material 1)

As to the Experiment Material 1, five gallons of EM BOKASHI are added into the drum thereof, and stirred so that the EM BOKASHI is evenly distributed in the material. Thereafter, the drum is closed by putting a cover thereon and placed in a quiet place for a month. The change occurring has been observed.

### Experiment 2 (Experiment Material 2)

Five gallons of EM BOKASHI are added to the Experiment Material 2 prepared above. The EM BOKASHI is evenly distributed in the material by stirring using a stirring stick. Thereafter, the drum is closed by putting a cover thereon and placed in a quiet place for a month. The change occurring has been observed.

### Experiment 3 (Experiment Material 3)

The Experiment Material 3 are subjected to the same treatment as the Experiment Material 2, except that one week after storing in the closed drum at a quiet place, the closed container is opened and the content is stirred while the content is exposed to air such that the content is exposed to air. Then, the drum is closed again and placed quietly for three weeks. The change occurring has been observed.

### Experiment 4 (Experiment Material 4)

The Experiment Material 4 are subjected to the same treatment as the Experiment Material 2, except that the inside wall of the container is double wall structured, and the inner wall of the double wall has a number of apertures. EM BOKASHI is stored between the inner wall and outer wall of the double wall structure. Under such condition, the container of the Experiment Material 4 is placed quietly for a month so that fermentation occurs. The result of the fermentation has been observed.

### Experiment 5 (Experiment Material 5)

Five gallons of EM BOKASHI are added to the Experiment Material 5 prepared above. The EM BOKASHI is evenly distributed in the material by stirring using a stirring stick. Thereafter, the drum is closed by putting a cover thereon and placed in a quiet place for a month. The change occurring has been observed.

### Experiment 6 (Experiment Material 6)

Five gallons of EM BOKASHI are added to the Experiment Material 6 prepared above. The EM BOKASHI is evenly distributed in the material by stirring using a stirring stick. Thereafter, the drum is closed by putting a cover thereon and placed in a quiet place for a month. The change occurring has been observed.

Result of Experiment

| | Experiment 1 | Experiment 2 | Experiment 3 | Experiment 4 |
|---|---|---|---|---|
| Odor | Putrefaction | Sour-sweet | Sour-sweet | Sour-sweet |
| | smell overall | smell partially | smell | smell |
| | | putrefaction | Overall | |
| | | smell | | |
| Color | Changed from | Faded out | Faded out | Faded out |
| | green to black | green partially | green Overall | green overall |
| | overall | changed into | | |
| | | black | | |

| | Experiment 5 | Experiment 6 |
|---|---|---|
| Odor | Strong | Sour-sweet smell |
| | putrefaction smell | Overall |
| | overall | |
| Color | Changed from | Remained in |
| | brown to black | brown, partially |
| | | changed into black |

From the result of Experiment 1, in a case where green wastes containing about 50% water content are fermented in anaerobic condition, the green wastes changed into black color as a whole and generated strong putrefaction smell.

From the result of Experiment 2, in a case where water content of the green wastes are adjusted to be 25%-35% by weight by sun-drying for half a day and then fermented, upon opening the cover of the drum after one month has passed since placing the content in a quiet place, a sour-sweet smell, which is peculiar to anaerobic fermentation, has been observed. However, observing more in detail, the green wastes changed into black color at portions near the upper cover of the container and at a portion proximate to the inner wall. Also, putrefaction smell has been a little observed at those portions.

From the result of Experiment 3, in a case where the cover of the drum is opened after one week has passed since anaerobic fermentation is started in the drum and the content is stirred to be exposed to outside air, and thereafter stored in the drum in a closed condition, the sour-sweet smell of the fermented green wastes has been stronger than the green wastes which was not subjected to such treatment (Experiment 2 case). It is inferred that the anaerobic fermentation has been further promoted by the above treatment.

From the result of Experiment 4, in a case where EM BOKASHI is placed between the double inside walls of the drum and organic wastes are subjected to anaerobic fermentation, the color change of the organic wastes near the inner wall of the container into black, which has been observed in Experiment 2, has never been observed. In addition, the sour-sweet smell caused by anaerobic fermentation was stronger than that of Experiment 2.

From the result of Experiment 5, in a case where green wastes already having putrefaction is subjected to anaerobic fermentation under the same condition as that of Experiment 1, the green wastes stored in the drum was partially putrefacted.

From the result of Experiment 6, even when the green wastes are partially putrefacted, by drying the green wastes to a water content of less than 10%, and then recovered up to 25%-35% by weight by adding EM diluted solution and then subjecting the green wastes to anaerobic fermentation under the same condition as that of Experiment 2, a same result as that of Experiment 2 has been obtained.

According to an embodiment of a method of composting organic wastes of the present invention, high quality compost with very little pathogenic bacteria can be produced without causing putrefaction to organic wastes and bad effect to surrounding environment by using EM fermented feed.

According to an embodiment of a method of composting organic wastes of the present invention, because the water content of the organic wastes is already appropriately controlled at the time the EM-fermented feed is added, it is not necessary to absorb excessive water by the EM-fermented feed which is added thereafter. As the result, amount of EM-fermented feed to be used can be saved.

According to an embodiment of a method of composting organic wastes of the present invention, because the preconditioning process is conducted in a chamber that is shut off from the outside air, the organic wastes are prevented from having putrefaction before going to the fermentation treatment. Therefore, anaerobic fermentation using EM-fermented feed can be more effectively performed.

According to an embodiment of a method of composting organic wastes of the present invention, the collected organic wastes are once dried to a water content less than 20% by weight, preferably less than 10% by weight and thereafter EM diluted solution is added such that water content of the organic wastes is recovered to a level in which anaerobic fermentation may occur, even if the collected organic wastes are partially putrefacted, anaerobic fermentation can be effectively performed without being affected by the putrefaction.

According to an embodiment of a method of composting organic wastes of the present invention, by heating the organic wastes at a high temperature at the preconditioning process, various germs, seeds of plants are killed. As the result, occurrence of bad smell caused by the germs or any problems caused by the growth of the seeds of plants can be prevented.

According to an embodiment of a method of composting organic wastes of the present invention, because the production of the compost is conducted all in a closed system, surrounding environment is not damages even when the fermentation failed.

According to an embodiment of a method of composting organic wastes of the present invention, because EM BOKASHI is used at the inner wall of the container as a fermentation promotion agent and water absorbing material, the organic wastes can be evenly composted in the container used for the fermentation. In addition, damage to the container used for fermentation caused by the high temperature of the water generated from the organic wastes.

According to an embodiment of a method of composting organic wastes of the present invention, because the kitchen wastes or green wastes can be collected by a mobile container truck having the preconditioning apparatus on the back bed thereof, and the organic wastes can be input into the preconditioning apparatus at the place of collection, the process can be performed very economically efficient manner. Also, because a large volume of the organic wastes already completed the preconditioning can be input into a large capacity fermentation tank from a plurality of the mobile trucks to be fermented therein, a large amount of compost can be produced economically and efficiently.

According to an embodiment of a method of composting organic wastes of the present invention, it becomes possible to solve the problems existing in preparing the facility for large scale production, and obtaining high quality compost, and to commercialize the production of organic manure from organic wastes.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for composting organic wastes, comprising:
chopping the organic wastes;
adjusting water content of the chopped organic wastes to about 20%-40% by weight;
mixing an effective amount of EM-fermented feed with the chopped organic wastes such that the EM-fermented feed is substantially evenly distributed in the chopped organic wastes; and
storing the chopped organic wastes having the EM-fermented feed in a closed container at suitable temperature for a predetermined period of time such that the chopped organic wastes are composted in the closed container by fermentation.

2. The method according to claim 1, wherein mixing the EM-fermented feed with the chopped organic wastes is conducted in a closed chamber.

3. The method according to claim 1, wherein chopping the organic wastes, adjusting water content of the chopped organic wastes, and mixing an effective amount of EM-fermented feed with the chopped organic wastes are all conducted in a closed chamber.

4. The method according to claim 1, wherein water content of the chopped organic wastes is adjusted to about 25%-35% by weight.

5. The method according to claim 1, wherein water content of the chopped organic wastes is initially more than 40% and the chopped organic wastes are heated at above 100° C. for a predetermined period of time such that the chopped organic wastes are dried to a water content of about 25%-35% by weight.

6. The method according to claim 2, wherein water content of the chopped organic wastes is initially more than 40% and the chopped organic wastes are heated at above 100° C. for a predetermined period of time such that the chopped organic wastes are dried to a water content of about 25%-35% by weight.

7. The method according to claim 1, wherein after the chopped organic wastes having effective amount of EM-fermented feed is stored in a closed container for a predetermined period of time, the closed container is opened and the chopped organic wastes are stirred to be exposed to outside air and then stored in the closed container again such that composting of the chopped organic wastes is completed in the closed container.

8. The method according to claim 2, wherein after the chopped organic wastes having effective amount of EM-fermented feed is stored in a closed container for a predetermined period of time, the closed container is opened and the chopped organic wastes are stirred to be exposed to outside air and then stored in the closed container again such that composting of the chopped organic wastes is completed in the closed container.

9. The method according to claim 1, wherein a predetermined amount of EM-fermented feed is coated on an inner wall of the closed container such that the organic wastes stored in the closed container is contacted with the EM-fermented feed during the fermentation.

10. The method according to claim 2, wherein a predetermined amount of EM-fermented feed is coated on an inner wall of the closed container such that the organic wastes stored in the closed container is contacted with the EM-fermented feed during the fermentation.

11. A method for composting partially putrefacted organic wastes, comprising:
chopping partially putrefacted organic wastes having water content of more than 40% by weight;
drying the chopped organic wastes by heating the chopped organic wastes at a temperature above 100° C. and stirring the heated chopped organic wastes such that the water content of the chopped organic wastes becomes less than 20% by weight;
adjusting water content of the dried chopped organic wastes to about 20%-40% by weight;
mixing effective amount of EM-fermented feed with the chopped organic wastes and stirring the chopped organic wastes such that the EM-fermented feed is substantially evenly distributed in the chopped organic wastes; and
storing the organic wastes having the EM-fermented feed in a closed container at a suitable temperature for a predetermined period of time such that the chopped organic wastes are composted in the closed container by fermentation.

12. The method according to claim 11, wherein water content of the dried chopped organic wastes is adjusted to about 20%-40% by weight by adding EM solution.

13. The method according to claim 12, wherein mixing EM-fermented feed with the chopped organic wastes is conducted in a closed chamber.

14. The method according to claim 12, wherein chopping partially putrefacted organic wastes, drying the chopped organic wastes, adjusting water content of the chopped organic wastes, and mixing EM-fermented feed with the chopped organic wastes are all conducted in a closed chamber.

15. The method according to claim 12, wherein water content of the chopped organic wastes is adjusted to about 25%-35% by weight.

16. The method according to claim 11, wherein water content of the chopped organic wastes is initially more than 40% and the chopped organic wastes are heated at above 100° C. for a predetermined period of time such that the chopped organic wastes are dried to a water content of about 25%-35% by weight.

17. The method according to claim 12, wherein water content of the chopped organic wastes is initially more than 40% and the chopped organic wastes are heated at above 100° C. for a predetermined period of time such that the chopped organic wastes are dried to a water content of about 25%-35% by weight.

18. The method according to claim 11, wherein after the chopped organic wastes having effective amount of EM-fermented feed is stored in a closed container for a predetermined period of time, the organic wastes is stirred to be exposed to outside air and then stored in the closed container again such that composting of the chopped organic wastes is completed in the closed container.

19. The method according to claim 12, wherein after the chopped organic wastes having effective amount of EM-fermented feed is stored in a closed container for a predetermined period of time, the organic wastes is stirred to be exposed to outside air and then stored in the closed container again such that composting of the chopped organic wastes is completed in the closed container.

20. The method according to claim 11, wherein predetermined amount of EM-fermented feed is coated on an inner wall of the closed container such that the chopped organic wastes stored in the closed container are contacted with the EM fermented feed during the fermentation.

21. The method according to claim 12, wherein predetermined amount of EM-fermented feed is coated on an inner wall of the closed container such that the chopped organic wastes stored in the closed container are contacted with the EM-fermented feed during the fermentation.

22. A method for composting organic wastes, comprising:
chopping organic wastes having water content of more than 40% by weight;
drying the chopped organic wastes by heating the chopped organic wastes at a temperature above 100° C. and stirring the heated chopped organic wastes such that the water content of the chopped organic wastes becomes less than 20% by weight;
adjusting water content of the dried chopped organic wastes to about 20%-40% by weight;
mixing effective amount of EM-fermented feed with the chopped organic wastes and stirring the chopped organic wastes such that the EM-fermented feed is substantially evenly distributed in the chopped organic wastes; and
storing the organic wastes having the EM-fermented feed in a closed container at a suitable temperature for a predetermined period of time such that the chopped organic wastes are composted in the closed container by fermentation.
